(19) United States
(12) Patent Application Publication
(10) Pub. No.: US 2026/0049697 A1
(43) Pub. Date: Feb. 19, 2026

(54) LIGHT AND BATTERY KEYED WITH AN ASYMMETRICALLY SHAPED TERMINAL

(71) Applicant: Streamlight, Inc., Eagleville, PA (US)

(72) Inventors: Thomas D. BORIS, Collegeville, PA (US); Daemon A. HECKMAN, Collegeville, PA (US)

(21) Appl. No.: 18/978,548

(22) Filed: Dec. 12, 2024

Related U.S. Application Data
(63) Continuation of application No. 29/957,946, filed on Aug. 16, 2024.

(51) Int. Cl. F21L 4/08; F21V 17/00; F21V 23/04; F21V 23/06; H01M 10/46; H01M 50/172; H01M 50/588

(52) U.S. Cl. CPC F21L 4/085; F21V 17/005; F21V 23/04; F21V 23/06; H01M 10/46; H01M 50/172; H01M 50/588; H01M 2220/30

(57) ABSTRACT

A portable light has a cavity configured for receiving the electrical power source and has an opening between the cavity and exterior to the portable light. A contact assembly in the cavity has an asymmetrical keying feature in a predetermined orientation in the cavity relative to the opening. An electrical power source has an asymmetrical electrical terminal configured to engage the keying feature in a predetermined orientation, and a charging port at a predetermined location relative to the asymmetrical electrical terminal. A cover includes an orienting member that engages a recess and/or projection of the electrical power source for moving the electrical power source into a predetermined orientation whereat the charging port of the electrical power source is accessible through the opening to receive charging current directly from an external charging source.

This Application claims the benefit and the priority of U.S. patent application Ser. No. 29/957,946 filed Aug. 16, 2024, entitled “BATTERY HAVING A D-SHAPED TERMINAL,” and is a continuing Application therefrom, and U.S. patent application Ser. No. 29/957,946 is hereby incorporated herein by reference in its entirety and for all purposes.

The present invention relates to a light and an electrical power source employing complementary shaped keying and/or orienting features; and also relates to an electrical power source having an asymmetrically shaped terminal.

Portable lights are ubiquitous, as are the sources of electrical power that energize them. Various types and sizes of sources of electrical power (herein referred to as a “battery” or “batteries” for convenience) have been developed over the decades as the technology of portable lighting has developed and as technologies have advanced. Many can remember the vintage incandescent lights and the heavy single-use D-cells that powered them for producing what by today's standards is inadequate levels (brightness) of light. Those batteries, typically carbon-zinc cells, were both heavy and relatively short lived.

Over the decades light sources that are more efficient and that produced greater brightness were developed, e.g., halogen lamps, xenon lamps, and ever improving light emitting diodes (LEDs), and replaced the older light sources. The desire for more light at lower power levels continues.

In parallel, better electrical power sources, e.g., batteries, were developed, including those having greater power densities (more milliampere-hours per unit weight) and longer shelf life (reduced self discharge). Single-use batteries continue in use along side of rechargeable batteries which have improving charging protocols. Either the light with the rechargeable battery inside was placed into a suitable charging device or the rechargeable battery was removed from the light and placed into a suitable charging device.

In recent years, various new battery chemistries and configurations, e.g., various lithium-based batteries, have been developed that include electronic charging controls in the same package as the battery cell, whereby the need for specific charging devices is reduced. In an age when portable computers, tablets, mobile phones and the like connect with a limited number of relatively standard electrical connectors, e.g., USB, mini-USB, micro-USB, USB-C, Firewire and Lightning connectors, some portable lights have come to include one of these or another common connector for receiving charging current from a standard source, e.g., a +5 VDC source. As a result, such portable lights can be connected to a standard charging source via a common cable, e.g., a USB cable and the like, thereby avoiding the need for a separate charging device. Where the charging connector of the light includes a USB connector, the charging connector may be referred to as a USB port.

In more recent times, an electrical charging connector has been included in certain rechargeable batteries so that those rechargeable USB batteries can be removed from the light and connected to such standard charging source via a common cable, e.g., a USB cable and the like, thereby avoiding the need for a separate charging device. Where the charging connector of the battery is a USB connector, the charging connector may be referred to as a USB port.

However, including the charging connector in the portable light increases both the size and cost of the light. In addition, a typical battery shape is often symmetrical, e.g., cylindrical, which can result in it being in any rotational orientation when in the portable light.

Applicant believes that it would be desirable to have a light wherein a battery therein may be charged directly via its charging connector when in the light and to avoid the increased size and/or cost of having a charging connector as part of the light.

Applicant also believes that it would be desirable that the typical battery having a symmetrical shape, e.g., a cylindrical shape, which is desired to be in a predictable rotational orientation when in the portable light, be configured in conjunction with the light to attain that predictable orientation.

Applicant also believes it would be desirable to have a rechargeable power source that includes a charging port that is compatible with and is configured for use in one or more specific lights and that may also be used in other different lights, wherein batteries that are usable in such other different lights are not usable in the specific lights, e.g., for technical, quality and/or compatibility reasons.

Further, Applicant believes that it would be desirable to have a power source that is configured to have a predetermined orientation when in a particular portable light wherein the configuration of the power source does not preclude the power source from being employed in other portable lights and other devices.

Accordingly, a portable light may comprise: a rotationally symmetrical electrical power source with one asymmetrical electrical terminal that is centrally located relative to an axis of rotation of the electrical power source and that is either raised or recessed, and an asymmetrical electrical contact of complementary shape that is either recessed or raised for engaging the asymmetrical electrical terminal.

A portable light may comprise: a light body having a cavity for receiving an electrical power source therein and having a first opening through which an electrical power source can be received therein, wherein the cavity has a substantially symmetrical shape and has a second opening through the light body to exterior the portable light; a light source supported for producing light; a substantially symmetrical electrical power source that is of compatible symmetrical shape and size with the cavity of the light body, the electrical power source having an asymmetrical electrical terminal at a first end thereof and a recess or a projection or a recess and a projection at a second end thereof, and having a charging port on the exterior thereof at a predetermined location relative to the asymmetrical electrical terminal; an asymmetrical keying feature of a shape and size for engaging the asymmetrical electrical terminal of the electrical power source when the electrical power source is in a predetermined orientation in the cavity whereat the charging port of the electrical power source is in alignment with the second opening; and a cover including an orienting member configured to engage the recess or the projection or both the recess and the projection of the electrical power source for rotating the electrical power source in the cavity to rotate the electrical power source into the predetermined orientation.

A portable light may comprise: a light source for producing light; an electrical power source having a substantially symmetrical exterior shape, having an asymmetrical electrical terminal and having a recess or a projection or both a recess and a projection thereon, and having a charging port on the symmetrical exterior shape thereof at a predetermined location relative to the asymmetrical electrical terminal; a light body having a cavity that is of compatible symmetrical shape and size for receiving the electrical power source, and having a first opening through which the electrical power source can be received into and removed from the cavity, and having a second opening between the cavity and exterior to the portable light; a contact assembly disposed in the cavity of the light body and having an asymmetrical keying feature configured to engage the asymmetrical electrical terminal of the electrical power source when the electrical power source is in a predetermined orientation in the cavity whereat the charging port of the electrical power source is in alignment with the second opening through the light body, and a cover configured to cover the first opening of the light body when the cover is thereon, the cover including an orienting member configured to engage the recess or the projection or both the recess and the projection of the electrical power source for moving the electrical power source in the cavity when the cover is placed on the light body to move the electrical power source into the predetermined orientation. As a result, the charging port of the electrical power source is accessible through the second opening through the light body to receive charging current directly from an external charging source when the electrical power source is in the predetermined orientation in the cavity of the light body.

A portable light may comprise: a light body having a forward end and a rearward end and an elongate portion therebetween with a cavity for receiving an electrical power source therein and having a first opening at the rearward end thereof through which an electrical power source can be received into and removed from the cavity, wherein the cavity has a substantially cylindrical shape and has a second opening through the elongate portion of the light body to exterior the portable light; a light source supported proximate the forward end of the light body for producing light when energized; an electrical power source having a substantially cylindrical exterior of compatible shape and size with the cavity of the light body, the electrical power source having an asymmetrical electrical terminal at a first end thereof and a recess or a projection or both a recess and a projection at a second end thereof, the electrical power source having a charging port on the exterior thereof at a predetermined location relative to the asymmetrical electrical terminal; a contact assembly disposed in the cavity of the light body and having an asymmetrical keying feature of a shape and size for engaging the asymmetrical electrical terminal of the electrical power source when the electrical power source is in a predetermined orientation in the cavity whereat the charging port of the electrical power source is in alignment with the second opening through the light body, and a tail cap configured to cover the first opening of the light body when the tail cap is rotated thereon, the tail cap including an orienting member extending towards the cavity to engage the recess or the projection or both the recess and the projection of the electrical power source for rotating the electrical power source when the tail cap is rotated on the light body to rotate the electrical power source into the predetermined orientation and to cover the first opening. As a result, an external charging source may be directly connected through the second opening to the charging port of the electrical power source.

An electrical power source for a portable light may comprise: a housing having an exterior shape that is substantially symmetrical about an axis thereof and that is of compatible symmetrical shape and size with a light body with which it is intended to be utilized; an asymmetrical electrical terminal at a first end of the housing and a recess or a projection or both a recess and a projection at a second end of the housing opposite the first end thereof; and a charging port on the substantially symmetrical exterior shape at a predetermined location relative to the asymmetrical electrical terminal; wherein the asymmetrical electrical terminal is configured to engage an asymmetrical keying feature of the light body with which it is intended to be utilized; wherein the recess or the projection or both the recess and the projection are configured for moving the electrical power source in the light body to move the asymmetrical electrical terminal into engagement with the asymmetrical keying feature.

In summarizing the arrangements described and/or claimed herein, a selection of concepts and/or elements and/or steps that are described in the detailed description herein may be made or simplified. Any summary is not intended to identify key features, elements and/or steps, or essential features, elements and/or steps, relating to the claimed subject matter, and so are not intended to be limiting and should not be construed to be limiting of or defining of the scope and breadth of the claimed subject matter.

### BRIEF DESCRIPTION OF THE DRAWING

The detailed description of the preferred embodiment(s) will be more easily and better understood when read in conjunction with the FIGURES of the Drawing which include:

FIGS. 1A and 1B are perspective views of an example embodiment of a portable light according to the present arrangement;

FIGS. 2A through 2G are perspective and other views of an example power source suitable for use with the example portable light;

FIG. 3 is a longitudinal perspective view of the example portable light illustrating an example internal arrangement thereof;

FIG. 4 is a longitudinal cutaway or cross-sectional view of the example portable light illustrating orientation and other features therein and an electrical contact assembly therein to which the power source makes connection when in the example portable light;

FIG. 5 is a perspective view of an example cover for the example portable light illustrating the interface thereof with the example power source;

FIGS. 6A-6B illustrate examples of alternative configurations for the terminals of alternative example power sources; and

FIGS. 7A to 7D illustrate a sequence of four example rotational positions of the example cover in relation to an example of the power source and the light body of the example portable light.

In the Drawing, where an element or feature is shown in more than one drawing figure, the same alphanumeric designation may be used to designate such element or feature in each figure, and where a closely related or modified element is shown in a figure, the same alphanumerical designation may be primed or designated “A” or “B” or the like to designate the modified element or feature. Similar elements or features may be designated by like alphanumeric designations in different figures of the Drawing and with similar nomenclature in the specification. As is common, the various features of the drawing are not to scale, the dimensions of the various features may be arbitrarily expanded or reduced for clarity, and any value stated in any Figure is by way of example only.

### DESCRIPTION OF THE PREFERRED EMBODIMENT(S)

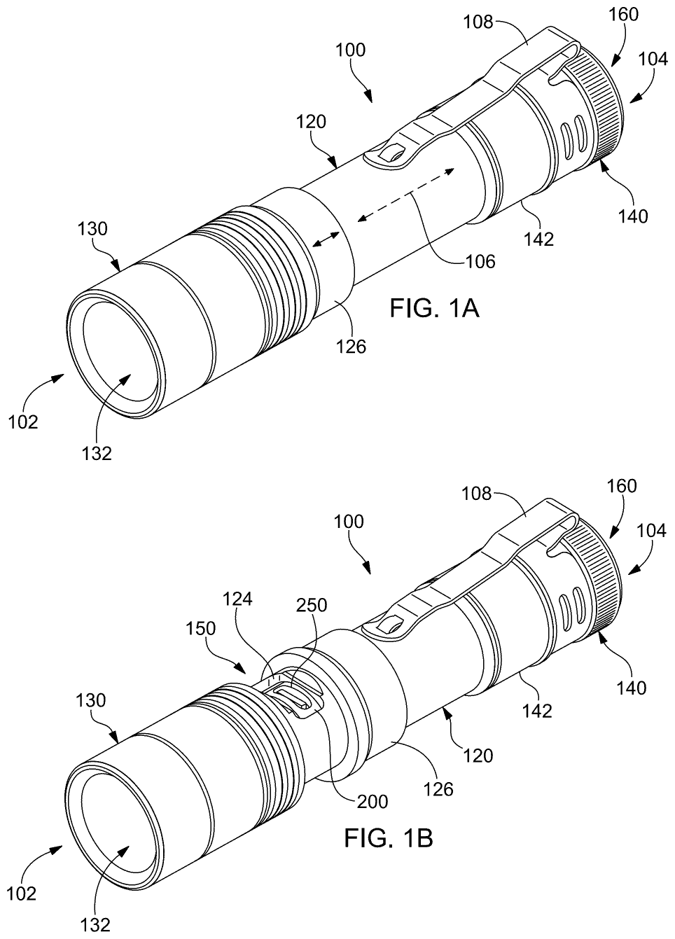

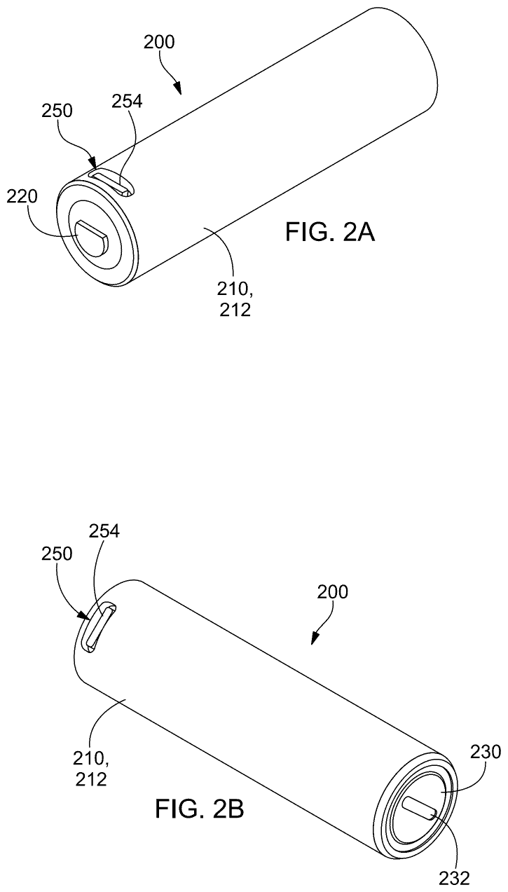

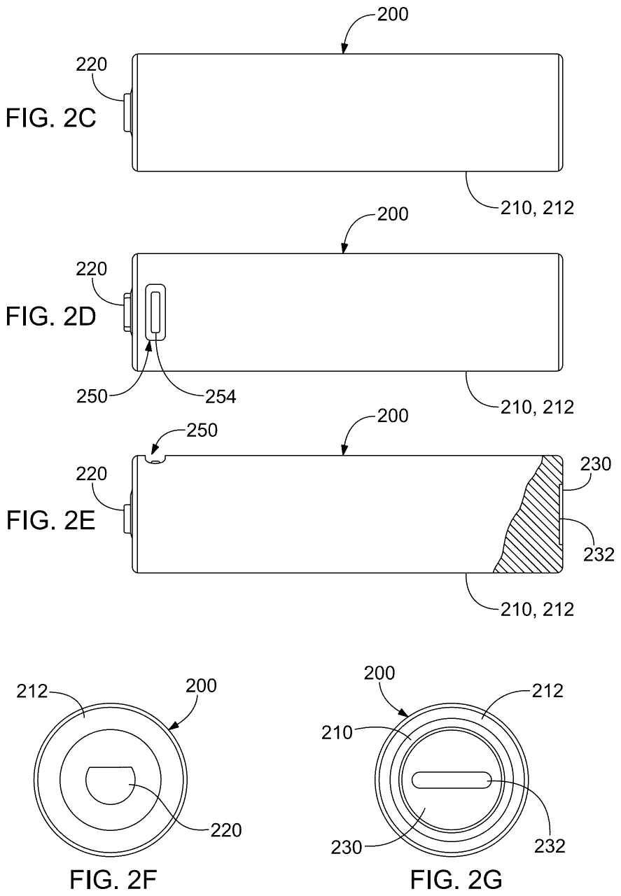

FIGS. 1A and 1B are perspective views of an example embodiment of a portable light 100 according to the present arrangement; and FIGS. 2A through 2G are perspective and other views of an example power source 200 suitable for use with the example portable light 100. Portable light 100 includes a light body 120 that supports a light head 130, e.g., at or near a first or forward end 102 thereof, and a cover 140 for covering and uncovering an opening through which a source of electrical power may be placed into and removed from the light 100. Cover 140 may also be referred to as a tail cap 140, e.g., as in the illustrated example where it is at a second or rearward end 104 of an elongate light body 120 that is remote from the light head 130 and light source 132 thereof.

Portable light 100 and light body 120 thereof in the illustrated example define a longitudinal direction 106 between forward end 102 and rearward end 104. Light head 130 includes a light source 132, e.g., typically including one or more light-emitting diodes (LEDs). Other configurations of light bodies 120 and light heads 130 are envisioned as are known in the art, and the arrangement described and claimed herein is suitable and compatible with many different configurations of portable lights.

Light body 120 has a compartment or cavity 122 therein which is configured to receive a source of electrical power 200, e.g., a battery 200. Power source 200 is also referred to herein as a battery 200, both of which are intended to include any suitable source of electrical power, whether being for a single use or being rechargeable or re-fuelable.

A battery opening 128 is provided in light body 120 through which a battery 200 may be received into and be removed from cavity 122. Battery opening 128 is coverable and/or closable by cover 140 being placed onto light body 120, e.g., by being rotated, to be retained thereon as a cover 140 over the battery opening 128 of battery cavity 122. For reasons that will become clear below, it is important that cover/tail cap 140 or at least a part thereof be movable, e.g., rotatable, relative to light body 120.

Light body 120 also has a charging opening 124 through a wall thereof, and charging opening 124 is located such that an external source of charging power may be connected directly to a power source 200 which is in cavity 122 of light body 120, e.g., connected directly to a charging port 250 of a rechargeable power source 200.

Advantageously, Applicant's arrangement eliminates the need for rechargeable power source 200 to be removed from light 100 to be charged and for light 100 to include a charging connector and internal circuitry for connecting a power source therein to the charging connector in order to be charged by an external source of charging power while in the light.

Light 100 can utilize a rechargeable battery 200 or other rechargeable power source 200 or a single use power source 200, or both, however, a rechargeable power source 200 is commonly utilized. Light 100 may include an electronic circuit and/or other features suitable for accommodating power sources and batteries of different types, voltages, and/or sizes, such as the circuits and features described in U.S. Pat. No. 8,779,683 entitled “Light Having a Circuit Accommodating Batteries of Different Types and/or Sizes,” U.S. Pat. No. 8,727,561 entitled “Light And/or Device Having a Compartment Accommodating Batteries of Different Types, Sizes And/or Shapes,” and U.S. Pat. No. 9,341,324 entitled “Portable Light Having a Sleeve Internal Thereto and Sleeve Therefor,” each of which is hereby incorporated herein by reference in its entirety for any and all purposes.

Specifically, a rechargeable power source 200 that includes a charging port 250 is preferred because that allows light 100 and power source 200 therein to be charged without requiring a special and/or separate charging device for light 100. Example power source/battery 200 includes an externally accessible charging port 250 thereon which typically includes an electrical connector 254 which may be of any suitable type or kind to which a charging cable or charging connector from an external source of charging current may connect.

Preferred electrical connectors 254 for charging port 250 include USB connectors because they are in widespread use and can be connected by readily available standard cables to many different external sources of electrical charging power, e.g., plug-in power blocks with a USB output connector, USB receptacles of many items of furniture and apparatus such as clocks and electrical wall outlets, portable computer USB ports, power packs with a USB output connector, and the like. In particular, coaxial connectors, USB connectors, mini-USB connectors, micro-USB connectors, USB-B connectors, USB-C connectors, Fire Wire connectors and/or Lightning connectors are small and compact, readily available, and can conduct suitable levels of charging current, and so are of a preferred sort for electrical connector 254 of charging port 250.

Source of electrical power 200 has an outer case or housing 210 defining an exterior or outer shape that is substantially symmetrical about an axis thereof and that is of compatible symmetrical shape and size with the cavity 122 of the light body 120, i.e. the source of electrical power 200 fits into the cavity 122 of the light body 120 and may be rotated therein about its axis which is substantially in alignment with the axis of the cavity and passes through the battery opening 128 of the cavity 122. In the illustrated example embodiment, power source 200 is substantially cylindrical, and cavity 122 is substantially cylindrical and is of slightly larger diameter so that battery 200 may easily be placed into and removed from cavity 122 and may be rotated therein about their substantially common axes.

Light 100 has in effect a “charging port” 150 that is provided by a charging opening 124 in light body 120 through which the charging port 250 of a power source/battery 200 in cavity 122 can be directly accessed from exterior to light 100 by a charging cable or other charging source that can make direct electrical connection to battery charging port 250. For that to be possible, light body 120 and battery 200 must be configured such that battery 200 is in the proper position in cavity wherein its charging port 250 is aligned with charging opening 124 that a charging cable can connect to battery charging port 250 through charging opening 124. References herein to “charging port” 150 of light 100 refer to the combination of the charging opening 124 of light 100 (of light body 120 thereof) and the charging port 250 of a power source 200 therein, and the term “charging port” may be used even when an electrical power source is not therein.

The example power source/battery 200 illustrated herein includes a substantially cylindrical case or housing 210 which contains the battery cell or cells and can contain electronics that controls the charging thereof. A first battery terminal 220 is provided on a first end of battery 200 and has an asymmetrical shape that defines one radial direction-example terminal 220 has a shape like the letter “D” and is referred to as being “D-shaped” wherein the flat side of the D-shaped terminal 220 defines the one radial direction, e.g., a radial line that is perpendicular to the flat side of the D-shaped terminal defines the one radial direction. In the example power source 200, terminal 220 is a raised D-shaped terminal 220, however, it may be, e.g., a terminal 220 having a D-shaped recess. Typically, example terminal 220 is a terminal of positive (+) electrical polarity.

Asymmetrical as used in relation to asymmetrical electrical terminal 220 and its complementary keying feature 184, which is also referred to as engaging feature 184, e.g., of contact assembly 180, includes that it defines one radial direction. That one radial direction may include a range of angles, e.g., typically an about ±10° range of angles, over which charging port 250 and connector 254 therein are aligned with charging opening 124 to the degree that an external charging cable can be directly connected to connector 254 through charging opening 124. The size of charging opening 124 is selected for that condition to obtain within expected tolerances, e.g., tolerances of size and of alignment of the battery 200 and of charging opening 124.

That condition of alignment obtains when asymmetrical electrical terminal 220 engages contact assembly 180, e.g., keying feature 184 thereof, so that electrical power source 200 and light body 120 of portable light 100 are keyed one to the other in a predetermined orientation. While the keying feature of light 100 includes an electrical contact to which asymmetrical electrical terminal 220 can make electrical contact, various configurations and arrangements of contact assembly 180, which may be a single element or plural elements as in the illustrated example 180, may be employed to provide both keying and electrical connection functionality.

Thus, the keying feature 180, 182, 184, e.g., may be an asymmetrical electrical contact by itself or may be an electrical contact with an associated asymmetrical keying feature, or a similar feature. Likewise, an asymmetrical electrical contact, e.g., may be an asymmetrical electrical contact by itself or may be an electrical contact with an associated asymmetrical keying feature, or a similar feature.

The tolerance of the suitable range of angles can be adjusted to be larger or smaller, e.g., by varying the size of the charging opening 124 of light body 120, primarily the length of charging opening 124 in the circumferential direction around portable light 100. Increasing the circumferential length of charging opening 124 will increase the acceptable tolerance, e.g., to an about ±20° range of angles, while decreasing the circumferential length of charging opening 124 will decrease the acceptable tolerance.

The asymmetrical electrical terminal 220 of the electrical power source 200 is in the illustrated example at an end thereof and the charging port 250 thereof is on a side thereof, wherein the predetermined location of the charging port 250 of the electrical power source 200 relative to the asymmetrical electrical terminal 220 thereof is at a predetermined distance from the end of the electrical power source 200 and at a predetermined radial angle with respect to an asymmetrical feature, e.g., the flat side of the D-shaped terminal 220, of the asymmetrical electrical terminal 220 of the electrical power source 200.

The predetermined radial angle with respect to the asymmetrical feature of the asymmetrical electrical terminal 220 of the electrical power source 200 is, e.g., in the illustrated example, about zero degrees; and the charging port 250 of the electrical power source 200 is closer to the end thereof including the asymmetrical electrical terminal 220 than to an end 230 distal therefrom.

The asymmetrical orientation feature or keying feature 184 of the contact assembly 180 is of a complementary shape and size to that of the asymmetrical electrical terminal 220 of the electrical power source 200. Contact assembly 180 includes electrical contact 182 and asymmetrical orientation feature 184, keying feature 184. References herein to the electrical contact, asymmetric contact, contact assembly, orientation feature and/or keying feature may be understood to include all or part or parts of contact assembly 180, 182 and/or 184, as indicated by the context.

The second and opposite end of example power source/battery 200 provides a second terminal 230 of opposite electrical polarity to terminal 220, e.g., a negative (−) polarity terminal. Second end of battery 200 has an orienting feature 232 configured to be engagable for rotating battery 200 in cavity 122, wherein such rotation of battery 200 and terminal 220 thereof are for orienting battery 200 in a desired rotational orientation in cavity 122 wherein the power source charging port 250 is aligned with charging opening 124 of light body 120, thereby to provide in effect a charging port 150 of light 100.

Thus, when battery 200 in cavity 122 is rotated to a radial orientation where charging port 250 is in alignment with charging opening 124 to provide external charging port 150, asymmetrical terminal 220 engages a complementary asymmetrical keying feature 184 of cavity 122 thereby to orient battery 200 in proper alignment with charging opening 124 to provide charging port 150 of light 100. Where terminal 220 is D-shaped as in the illustrated example, the complementary keying feature 184 is also D-shaped to engage D-shaped terminal 220 at a particular radial orientation. Battery 200 may also include an exterior sheath or sleeve 212 which may provide, e.g., an outer insulator and/or for labeling.

Light 100 includes a switch and/or actuator, e.g., a switch actuator 160, for controlling the energizing and de-energizing of light source 132. Switch actuator 160 typically includes an actuator 145 on the exterior of light 100 for actuating an electrical switch 144 internal to light 100 which is coupled to electrical circuitry including light source 132 and battery 200 of light 100. In the illustrated example embodiment, a switch actuator 160 is provided on tail cap 140, however, one or more switch actuators 160 of the same or different form may be provided elsewhere on light 100, e.g., on a side thereof toward the forward (light producing) end thereof, in addition to or in place of switch actuator 160 on tail cap 140. Alternatively or additionally, a light head 130 may be configured to be rotatable to provide an ON/OFF switching functionality.

Light 100 may be provided with a port cover 126 for covering and uncovering charging opening 124 of charging port 150 for, e.g., reducing the entry of debris into cavity 122 of light 100. In the illustrated example, a collar 126 is provided that at least partially surrounds light body 120 and is slidable along the exterior of light body 120 so that it can be slid forwardly towards light head 130 for covering charging opening 124 and slid rearwardly away from light head 130 for uncovering charging opening 124. A resilient seal is preferably provided between collar 126 and light body 120, e.g., either on collar 126 or surrounding charging opening 124, as a seal and/or for frictionally causing collar 126 to tend to remain in the position to which it is moved on light body 120.

Examples of cover 126 may include: an annular collar 126 slidable along the light body 120 for covering and uncovering the charging opening 124 through the light body 120; or an end cap 126 slidable on the light body 120 for covering and uncovering the charging opening 124 through the light body 120; or a cover 126 movable toward and away from the light body 120 for covering and uncovering the charging opening 124 through the light body; or a cover 126 movable toward and away from the light body for covering and uncovering the charging opening 124 that is of a size and shape to be retained in the charging opening 124; or a cover 126 slidable along the light body 100 for covering and uncovering opening 124 that is of a size and shape to be retained in the charging opening 124.

Charging opening 124 and battery opening 128 may be referred to, e.g., either one as a first opening or as a second opening, and the like, with their respective function being provided by the context. For example, charging opening 124 may be referred to as a second opening and the wording that it is through the light body or it is alignable with the charging port of the power source providing the context and/or function. Light 100 may also be provided with various different types and kinds of accessories, such as a clip 108, a lanyard, colored lenses, and the like, as may be desired.

Further regarding the electrical power source 200 of FIGS. 2A through 2G, a portable light 100 may comprise a rotationally symmetrical electrical power source 200 with one asymmetrical electrical terminal 220 that is centrally located relative to an axis of rotation of the electrical power source 200 and that is either raised or recessed, and an asymmetrical electrical contact 180, 182, 184 of complementary shape that is either recessed or raised for engaging the asymmetrical electrical terminal 220, thereby to key the electrical power source 200 in a predetermined radial orientation. Asymmetrical electrical contact 180, 182, 184 of complementary shape may be and preferably is disposed in cavity 122 of light body 120.

In one embodiment, electrical power source 200 is of a shape and size that is common to commercially available electrical power sources, e.g., an AAA size, an AA size, a C size, a D size, or a CR-123 size power source, and so can be utilized in lights and other devices that utilize such commercially available electrical power sources. Typically, particular characteristics and/or quality standards of electrical power source 200 support its being utilized in lights of the sort described herein, e.g., example light 100, where, in many instances, the use of common sources of electrical power therein may not be desired, e.g., for various technical and/or commercial reasons. Yet in many instances, other lights and other electrically powered devices include a battery compartment sized to receive a standard-size, commercially available battery, so an electrical power source 200 having a size and arrangement of electrical terminals 220, 230 that is compatible with and operable in such a battery compartment is advantageous.

In one example, the one asymmetrical electrical terminal 220 is circular except for an indentation on the periphery thereof, e.g., defining a terminal in the shape of a letter “D” or a circle with a “V-shaped”or other indentation, whereby terminal 220 is asymmetrical. Alternatively, the one asymmetrical electrical terminal has the shape of a keyhole, or of a circle missing a V-shaped part, or of a central part and a smaller satellite part. Because certain ones of this asymmetrical electrical terminal 220 fit within the size and shape of electrical terminals of commonly available sources of electrical power, power source 200 may be utilized in lights and other devices that employ such commonly available power sources. The illustrated power source 200 reflects a Streamlight SL-B34 USB battery.

However, because light 100 includes a contact assembly 180 configured to accept only a power source 200 with a predetermined shape of an asymmetrical electrical terminal 220, common electrical power sources with incompatible electrical terminals, e.g., symmetrical electrical terminals, cannot be received by contact assembly 180 and so will not be able to connect to or to function in light 100, thereby precluding an electrical power source that might damage or otherwise not be compatible with light 100 from being used therein.

The asymmetrical electrical contact 180, 182 may have an electrical contact 182 that is recessed relative to an asymmetrical keying feature 184. The asymmetrical keying feature 184 may be and preferably is of an electrically insulating material.

The asymmetrical keying feature may have a shape of a letter “D,” or of a keyhole, or of a circle missing a V-shaped part, or of a central part and a smaller satellite part.

The electrical power source 200 has an orienting feature 232 that is raised or recessed. The orienting feature 232 is centrally located relative to the axis of rotation of the electrical power source and is at an end thereof opposite to the asymmetrical terminal 220. It is noted that the presence or absence of orienting feature 232 does not affect power source 200 being used in lights and devices than light 100.

The portable light may further comprise a rotatable cover 140 for retaining the electrical power source 200 and having an orienting member 146 to rotate the electrical power source 200.

The electrical power source 200 may have a charging port 250 in a predetermined location relative to the asymmetrical electrical terminal 220. The orienting member 146 of cover or tail cap 140 engages the orienting feature 232 for aligning the asymmetrical electrical terminal 220 with the asymmetrical electrical contact 180, 182, 184, whereby asymmetrical electrical terminal 220 and electrical contact 180, 182 come into electrical contact.

The charging port 250 is in a predetermined location relative to portable light 100 when the asymmetrical electrical terminal 220 is connected to the asymmetrical electrical contact 182, 184, e.g., engaged therewith. Thus, electrical power source 200 can be directly charged from an external charging source that connects to the charging port 250 of power source 200 through charging opening 124 in light body 120 of portable light 100, which is an advantageous feature.

The electrical power source 200 may have a charging port 250 in a predetermined location relative to the asymmetrical electrical terminal 220. The portable light may have an opening 124 in a predetermined location relative to the asymmetrical electrical contact 182, wherein the charging port 250 aligns with the opening 124 when the asymmetrical electrical terminal 220 engages the asymmetrical electrical contact 182.

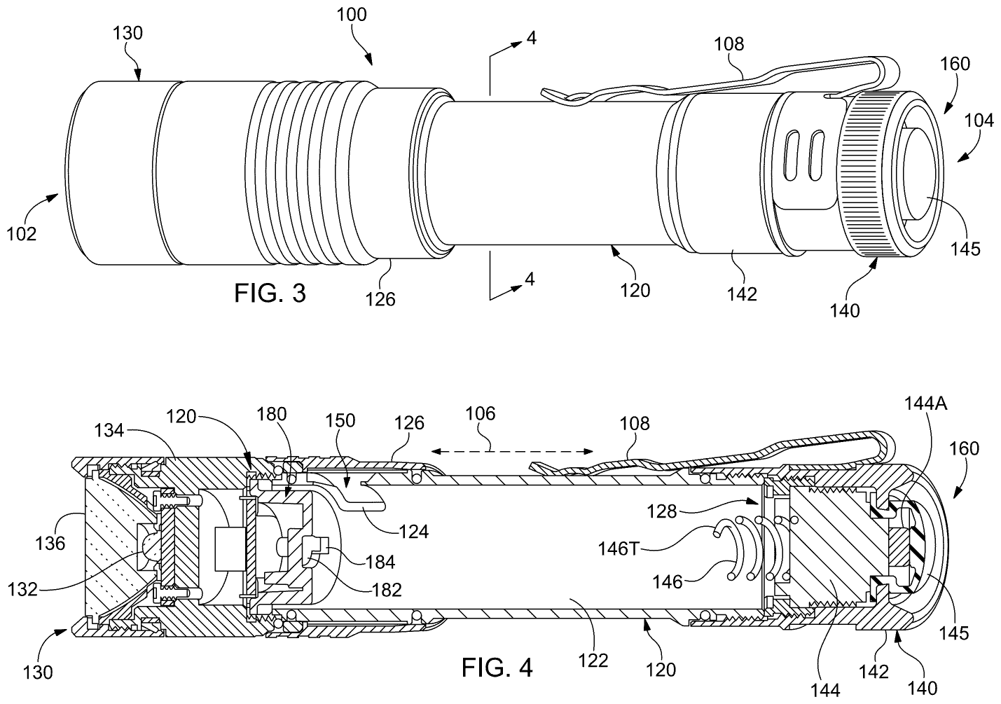

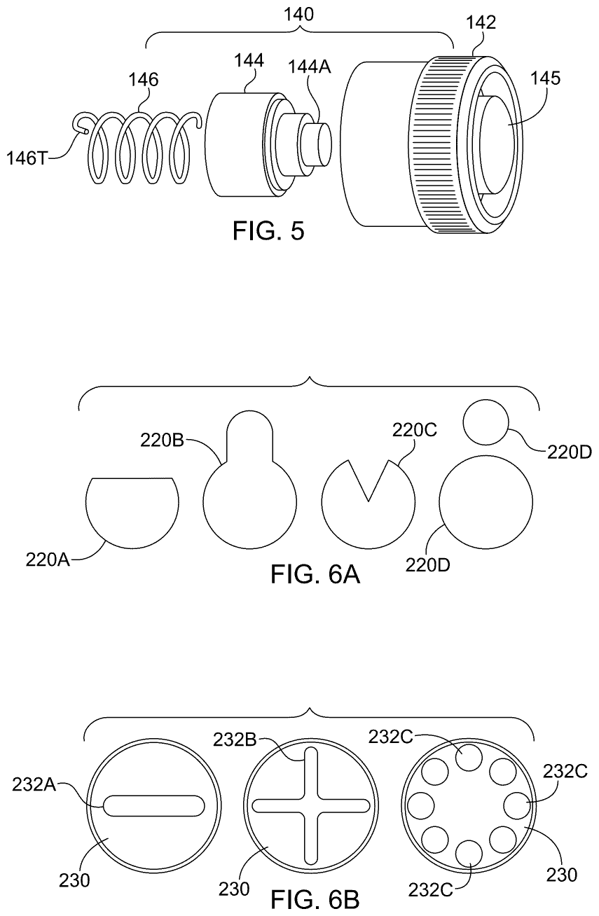

FIG. 3 is a longitudinal cross-sectional view of the example portable light 100 illustrating an example internal arrangement thereof; FIG. 4 is a longitudinal cutaway or cross-sectional view of the example portable light 100 illustrating orientation or keying feature 184 and other features therein and an electrical contact assembly 180 therein to which the power source 200 makes connection when in the example portable light; and FIG. 5 is a perspective view of an example cover 140 for the example portable light illustrating the interface thereof with the example power source. Electrical contact 182 and keying feature 184 of assembly 180 are at the end of cavity 122 that is distal from battery opening 128 thereof.

Example light body 120 has a cavity 122 configured to receive a source of electrical power 200 therein and has a battery opening 128 at one end thereof through which the power source 200 is inserted and removed. Battery opening 128 is covered by a removable cover 140, e.g., a removable tail cap 140, which is removable from light body 120 to facilitate placing the power source 200 into cavity 122 of light body 120 and removing it therefrom.

Example light head 130 is an assembly 130 including a housing 134 and a light source 132 and optical elements 136 therein and is supported by light body 120, e.g., near or at the forward end 102 thereof in the illustrated example. Typically, light source 132 includes a light-emitting diode (LED) 132 or another light-producing element and various optical elements, e.g., a reflector, a solid optic, a lens and the like, for shaping the light produced by light source 132 into a beam of light having desired characteristics. Light head 130 and light source 132 can be of many different types, shapes and configurations, e.g., straight as illustrated, angled, pivoted, articulated, or on a stalk, as is known in the art.

Example cover 140 is also referred to as a tail cap 140 because it covers the battery opening 128 of light body 120 of light 100 at the rear or tail end of the illustrated example of a light 100. Cover 140 is an assembly that is attachable to light body 120 to cover battery opening 128 of cavity 122 through which a power source 200 may be placed into and removed from light 100 and light body 120 thereof and is removable from light body 120 to uncover battery opening 128. Example cover/tail cap 140 includes a housing 142 which in the illustrated example supports a switch actuator 160 which is actuatable for controlling the energization and de-energization of light source 132.

Cover 140 also includes an orienting member 146 that engages a power source 200 that is in cavity 122 of light 100 to move, e.g., rotate, the power source 200 into a desired orientation within cavity 122. That desired orientation is a predetermined orientation whereat the charging port 250 of power source 200 aligns with charging opening 124 of light 100 so that charging port 250 of power source 200 is directly accessible through charging opening 124 for recharging power source 200. Orienting member 146 may provide functionality in addition to orienting power source 200, e.g., providing an electrical contact or connection and/or pressing power source 200 in a direction towards contact assembly 180, e.g., axially forward, when cover 140 is attached to light body 120.

In the illustrated example embodiment, cover 140 includes a switch actuator 160 for actuating an electrical switch 144 in housing 142 of cover 140 that controls energization and de-energization of light source 132 and is actuated by pressing on flexible actuator 145 and releasing pressure on flexible actuator 145 of switch actuator 160. Orienting member 146 of cover 140 in the illustrated embodiment employs a spring contact 146 of switch 144 for orienting battery 200 as well as for making electrical contact with the end 230, e.g., terminal 230, of battery 200.

In this example, the tip 146T of spring 146 serves as an orienting member 146 that engages to move battery 200, e.g., to rotate battery 200, into the predetermined orientation whereat charging port 250 thereof properly aligns with charging opening 124 of light 100 As a result, a connector or cable from an external source of charging current can be directly connected through charging opening 124 to charging port 250 and its electrical connector 254 of battery 200 while battery 200 is disposed inside light 100 for charging battery 200, to in effect provide a charging port 150 for light 100.

Light body 120 and cover/tail cap 140 are configured such that they become attached to each other via a relative motion, e.g., rotation, of one with respect to the other. One suitable example configuration thereof is for each to have threading that is compatible with the threading of the other. For example, light body 120, e.g., specifically a battery opening 128 thereof, may have external threads, and cover/tail cap 140, e.g., specifically housing 142 thereof, may have internal threads that are of the same diameter and pitch as the external threads of light body 120, e.g., battery opening 128 thereof. Alternatively, a bayonet attachment arrangement of the sort used with bayonet lamp bases may be employed. Further, other rotationally activated latching or engagement arrangements may be employed. For example, cover/tail cap 140 and light body 120 may move and attach in other ways, such as through a hinge or other pivotable arrangement in conjunction with a releasable latch or clasp arrangement.

Rotation of tail cap 140 relative to light body 120 is preferably sufficient for the orienting member 146 of the tail cap 140 to engage the engaging feature 232 of the terminal 230 of power source 200 and rotate power source 200 into a proper predetermined orientation in cavity 122, as described herein. Typically, that functionality may employ about one full rotation or less from when the orienting member 146 of tail cap 140 engages the engaging feature 232 at the rearward end 230 of power source 200 as tail cap 140 is rotated onto light body 120. Therein, orienting member 146 makes physical contact with the rearward end 230 of the power source 200.

Battery opening 128 and cavity 122 are preferably of like symmetric cross-sectional shape, e.g., cylindrical in shape and so having a circular cross-section, and are preferably of substantially the same diameter and in alignment, e.g., their axis is substantially in the longitudinal direction of light 100 in the illustrated example, whereby the insertion and removal of power source 200 into and out of cavity 122 through battery opening 128 is facilitated.

Example light 100 includes an example cover/tail cap 140 that includes a switch actuator 160 at the rearward end 104 of light 100. Cover/tail cap 140 includes an orienting member 146, e.g., a spring or other member, extending in the direction towards power source 200 for physically contacting the end 230 of power source 200 to make physical contact therewith to engage power source 200 to orient it, e.g., rotate it, into a desired predetermined rotational orientation, or to both make electrical connection with and to engage and rotate power source 200 to orient it into the desired predetermined rotational orientation.

Alternatively, the orientation features 146 and/or 232 may not be present, in which case the user of light 100 may align the power source 200 into the correct predetermined orientation by pressing a finger or thumb against battery terminal 230 for rotating power source 200 until the asymmetric electrical terminal 220 thereof engages with the keying feature 180, 182, 184 in light body 120.

The example cover/tail cap 140 includes an electrical switch 144 that includes the spring 146 and when cover/tail cap 140 does not include an electrical switch or includes an electrical switch lacking a spring, an orienting member 146 is mechanically fastened to cover/tail cap 140 such that it extends toward power source 200 in the same manner as when a spring 146 is included in cover 140, either as part of switch 144 or separately therefrom. Thus, the arrangement for orienting power source 200 in light body 120 is the same irrespective of whether cover/tail cap 140 includes an electrical switch 144 or does not include an electrical switch.

Example switch actuator 160 is flexible for actuating an electrical switch 144 in tail cap housing 142 which has an actuating feature 144A, e.g., a pushbutton, positioned where it can be actuated through an opening in the rearward end of tail cap housing 142. That opening of housing 142 is typically is covered by a flexible actuator 145 which flexes to communicate force and movement of a user's finger to depress and release actuating feature 144A. Switch 144 in the illustrated example includes orienting member 146 which is provided by a spring 146, e.g., a helical or conical spring 146 or a leaf spring, having an end or tip 146T that extends in the forward longitudinal direction from tail cap 140 to engage power source 200, in particular the orienting feature 232 of the end 230 of power source 200.

Where orienting member 146 is a coil spring 146 or a leaf spring 146, the end or tip 146T thereof preferably extends in a generally inwardly and forwardly direction so as to be in a position and orientation whereat it engages orienting feature 232 of power source 200 in a location and orientation to engage therewith while causing power source 200 to rotate in cavity 122 as tail cap 140 is rotated onto light body 200. The rotation of power source 200 continues until asymmetrical terminal 220 thereof, which is configured asymmetrically to serve as a keying member 220, e.g., D-shaped terminal 220, that engages with keying feature 184 of contact assembly 180 whereat power source 200 is in a desired predetermined orientation whereat its charging port 250 is aligned with charging opening 124 to provide in effect a charging port 150 of light 100.

The location and number of switch actuators 160 provided is not constrained by whether or not a switch actuator 160 is provided in tail cap 140. Light 100 may be provided with one or more switch actuators which may be in a location or locations that the designer of light 100 thinks may be convenient and/or useful to a user of light 100, e.g., at one or more locations along the side thereof, as well as the rearward end 104 as in the illustrated example.

In any case, cover 140 may include an orienting member 146 whether that orienting member is a separate member or is provided by an element of cover 140, e.g., a switch 144 thereof. Alternatively, cover 140 may omit an orienting member 146, and in lieu thereof, the user may orient the power source 200 into the correct predetermined alignment by pressing and rotating power source 200 using a finger or thumb on terminal 230 thereof.

FIGS. 6A-6B illustrate examples of alternative configurations for the asymmetrical keying terminals 220 and terminal 230 of alternative example power sources 200. By way of examples, FIGS. 6A-6B illustrate four examples of alternative configurations for the asymmetrical first terminals 220 of example power sources 200 and three examples of alternative configurations for the second terminals 230 of example power sources 200, respectively. Regarding all illustrated examples, first terminal 220, or asymmetrical electrical terminal 220, of power source 200 and charging port 250 thereof are in predetermined locations radially and longitudinally relative to each other and similarly, keying feature 184 of contact assembly 180 of light 100 and charging opening 124 of light body 120 are in corresponding predetermined locations radially and longitudinally relative to each other so as to enable charging port 250 of power source 200 to be in alignment with charging opening 124 of light 100 thereby to define and provide an externally accessible charging port 150 of light 100.

FIG. 6A illustrates example asymmetrical first terminals 220A, 220B, 220C and 220D of example power sources 200 that are each of an asymmetrical shape that defines a unique radial direction of power source 200. Example first terminal 220A has a “D-shape” (i.e. a shape like a letter “D”) wherein a radial perpendicular to the flat side of the “D” defines the unique radial direction, example first terminal 220B has a radial bulge wherein the radial center line of the bulge defines the unique radial direction, example first terminal 220C has a “V-shaped” indentation (i.e. a shape like a letter “V”) wherein a radial through the point of the “V” defines the unique radial direction, and example first terminal 220D has a circular central part and a satellite part that is an adjacent nub, projection or recess wherein the radial passing through the center of the adjacent nub, projection or recess defines the unique radial direction. For terminal 220D, both parts thereof need not be the same form, e.g., the central circular part can be projecting while the satellite part is recessed. For each of these examples, the keying feature 184 of contact assembly 180 of light 100 recesses and/or projections of complementary shapes and/or sizes that similarly define the same unique radial direction whereby the charging port 250 of power source 200 aligns with charging opening 124 of light 100.

FIG. 6B illustrates example second terminals 230A, 230B, and 230C of example power sources 200 that are configured to provide an orienting feature 232 that is configured for being engaged by an orienting member 146 of cover 140. Therein, example orienting feature 232A is a diagonal recess or ridge 232A which is engagable by orienting member 146 at either of two diametrically opposite locations that are about 180° apart rotationally. Example orienting feature 232B therein is a cross or “X-shaped” recess or ridge 232B (i.e. a shape like a letter “X”) which is engagable by orienting member 146 at any of four opposite locations that are about 90° apart rotationally. Example orienting feature 232C therein includes a plurality of nubs, recesses or ridges 232C, or a plurality of both raised and recessed orienting features 232C, arranged in a circular pattern on terminal 230 which are engagable by orienting member 146 at a plurality of locations that are about 360°/N apart rotationally, e.g., at eight locations that are 360°/8 or about 45° apart rotationally in the illustrated example.

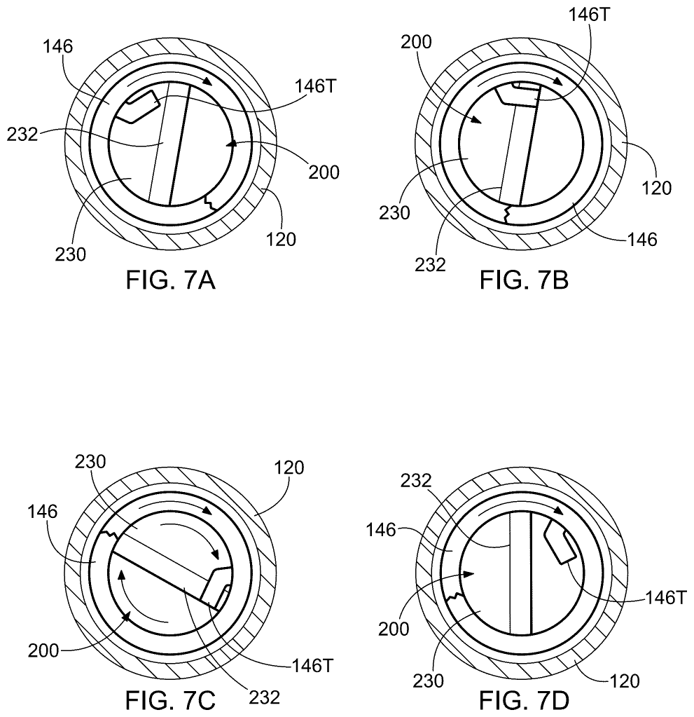

FIGS. 7A to 7D illustrate a sequence of four example rotational positions of rotation of the example cover 140 in relation to an example power source 200 that has an orienting feature 232 and the light body 120 of the example portable light 100. Therein the views are from a plane that intersects orienting member 146, e.g., a spring 146, looking in the forward direction at the example rearward end 230 of power source 200 which is in cavity 122 of light body 120. The curved arrow on spring 146 indicates the direction of rotation of cover 140 and spring 146 thereof relative to light body 120. For simplicity, power source 200 is referred to as battery 200 regarding these figures and throughout this specification.

In FIG. 7A, by rotation of cover 140 in the direction of the curved arrow, e.g., clockwise, relative to light body 120, orienting member 146, e.g., spring 146, and specifically the tip 146T thereof moves in a generally circular path towards the orienting feature 232, e.g., recess or ridge 232, of the end 230 of battery 200.

In FIG. 7B, by further rotation of cover 140 in the direction of the curved arrow relative to light body 120, spring 146 and specifically the tip 146T thereof continues moving along the generally circular path and comes into physical engagement with the orienting feature 232 of battery 200 thereby to begin rotating battery 200 in the direction of the curved arrow with further rotation of cover 140.

In FIG. 7C, with further rotation of cover 140 in the direction of the curved arrow on orienting member 146 relative to light body 120, spring 146 and specifically the tip 146T thereof move in the clockwise direction remaining in physical engagement with the orienting feature 232 of battery 200 and thereby continues moving along the generally circular path to continue rotating battery 200 in cavity 122 in the direction of the two curved arrows on end 230 thereof. Such rotation of battery 200 which results from its engagement with spring 146 (FIG. 7B) continues until the terminal keying feature 220 of battery 200, e.g., D-shaped terminal 220, at the opposite end of battery 200 comes into alignment with and engages keying feature 184, also called orientation feature 184, e.g., a D-shaped receptacle, of contact assembly 180 of light body 120.

Because battery 200 is urged forwardly by orienting member 146, e.g., spring 146, terminal and keying feature 220 thereof is urged forwardly to engage with keying feature 184 of contact assembly 180 in a predetermined unique rotational position whereat charging port 250, e.g., USB port 250, of battery 200 is aligned with charging opening 124 of light body 120 thereby to provide an externally accessible charging port 150 of portable light 100 such that an external charging cable can be directly connected through aligned charging opening 124 to battery charging port 250 thereby to provide charging port 150 of light 100.

When spring 146 urges terminal and keying feature 220 of battery 200 forwardly for engaging into contact assembly 180, battery terminal 220 makes electrical connection to electrical contact 182 of light body 120 and thus battery 200 is electrically connected in circuit with light source 132, switch actuator 160 and, e.g., other control circuitry, of light 100. Contact assembly 180 preferably is configured such that only an asymmetrical terminal like shaped forward terminal 220 of battery 200 can make electrical connection to contact 182, thereby to prevent battery 200 from connecting to the circuitry of light 100 in an incorrect polarity and to prevent an incompatible battery from being connected to the circuitry of light 100. Electrical coupling of the second end of battery 200 at the rearward end 104 of light 100 and light source 132 is typically provided via light body 120, cover 140 and spring 146 being of electrically conductive material, e.g., aluminum, spring steel or another metal, or may be provided by a separate electrical conductor that extends forwardly within light 100.

In FIG. 7D, further rotation of cover 140 in the direction of the curved arrow relative to light body 120 after asymmetrical electrical terminal 220 of battery 200 has engaged with keying feature 184 of contact assembly 180 causes spring 146 and specifically the tip 146T thereof to disengage physically from the orienting feature 232 of battery 200 and continue moving along the surface of terminal 230 in a generally circular path in the direction of the curved arrow. Thus, after asymmetrical electrical terminal engages keying feature 184, battery 200 does not continue rotating in cavity 122 and remains in the predetermined rotational orientation whereat the charging port of battery 200 and charging opening 124 of light body 120 are aligned, thereby to provide the externally accessible charging port 150 of portable light 100 through which an external source of charging power can be directly connected to the battery charging port 250 of battery 200 whilst battery 200 remains in cavity 122 of light body 120 of portable light 100. Battery 200 may also be removed from light 100 for being charged.

In the example illustrated embodiment, the rotation of battery 200 in cavity 122 that could be needed to bring battery charging port 250 into alignment with charging opening 124 of light body 120 to provide the charging port 150 is typically less than a complete rotation.

Alternative configurations of power source 200 and/or portable light 100 can be employed reduce the rotation needed to obtain that desirable result. For example, two openings can be provided through light body 120 at locations about 180° apart rotationally or a power source 200 with two charging ports 250 that are about 180° apart rotationally could be provided. It is again noted that all rotations described are examples and may not reflect rotation for alternative embodiments.

In addition, any of asymmetrical terminals 220, 220A, 220B, 220C, 220D as well as alternative shapes thereof may be raised terminals and/or may be recessed terminals, and keying features 184 therefor would then be complementary recessed and/or raised features. Similarly, any of orienting features 232, 232A, 232B, 232C and alternative shapes therefor may be raised features and/or may be recessed features.

For example, the asymmetrical electrical terminal 220 of the electrical power source 200 may have a shape of a letter D, or a keyhole, or of a circle missing a V-shaped part, or of a central part and a satellite part, The satellite part may be smaller than the central part, and/or may be recessed and the central part projecting.

For example, the recess or projection or both a recess and a projection providing orienting feature 232 at the second end of the electrical power source 200 may be a radial slot, or a radial ridge, or an X shape ridge or recess, or a circular pattern of projections and/or recesses, or a star shaped projection or recess, or an asterisk shaped projection or recess, or another suitably shaped projection or recess or both.

In a typical embodiment, various parts, e.g., light body 120, light head housing 134, tail cap housing142, and the like may be a nylon, reinforced nylon, engineered nylon, nylon 6, nylon 66, polyamide, polyamide 66, reinforced polyamide, reinforced polyamide 66, acrylonitrile butadiene styrene (ABS), polycarbonate, polyethylene, polypropylene, polycarbonate, polyester-polycarbonate blend, ABS polycarbonate blend, or other suitable plastic material, or of a cast, molded, forged, or machined metal. Resilient and/or flexible parts, e.g., flexible cover 145, O-rings and other sealing elements, such as those for port cover 126, may be of any suitable flexible and/or resilient material, e.g., rubber, neoprene rubber, elastomers, thermoplastic elastomers (TPEs), silicones, urethanes, MONOPRENE® rubber, nylon-bondable SANTOPRENE® rubber, HERCUPRENE rubber, NYLABOND® TPE material, AuroraFlex™ TPE material, and other suitable materials.

Metal parts, such as light body 120, light head housing 134, tail cap housing 142, spring 146 and other springs and fasteners, may be of any suitable metal, e.g., aluminum, steel, spring steel, metal wires, brass, bronze, phosphor bronze, magnesium, beryllium copper, cast metal, and the like. Where a part provides heat sinking, e.g., light head housing 134, such may include a relatively highly thermally conductive material such as aluminum, brass, copper, magnesium, cast metal, and/or a plastic filled with thermally conductive particles, e.g., a thermally conductive reinforced nylon, engineered nylon, acrylonitrile butadiene styrene (ABS), polycarbonate, polyethylene, polypropylene, polycarbonate, polyester-polycarbonate blend, ABS polycarbonate blend, or other suitable thermally conductive plastic material, e.g., a plastic that includes (is filled with) thermally conductive particles, flakes, strands or other thermally conductive material, as well as other materials having suitable strength and thermal conductivity.

A portable light comprising a rotationally symmetrical electrical power source with one asymmetrical electrical terminal that is centrally located relative to an axis of rotation of the electrical power source and that is either raised or recessed, and an asymmetrical electrical contact of complementary shape that is either recessed or raised for engaging the asymmetrical electrical terminal. The portable light wherein the one asymmetrical electrical terminal has a shape of a D, or of a keyhole, or of a circle missing a V-shaped part, or of a central part and a satellite part. The portable light wherein: the asymmetrical electrical contact has an electrical contact that is recessed relative to an asymmetrical keying feature; or the asymmetrical electrical contact has an electrical contact that is recessed relative to an electrically insulating asymmetrical keying feature. The portable light wherein the asymmetrical keying feature has a shape of a D, or of a keyhole, or of a circle missing a V-shaped part, or of a central part and a satellite part. The portable light wherein the electrical power source has an orienting feature that is raised or recessed. The portable light wherein the orienting feature is centrally located relative to the axis of rotation of the electrical power source and is at an end thereof opposite to the asymmetrical terminal. The portable light further comprising a rotatable cover for retaining the electrical power source and having an orienting member to rotate the electrical power source. The portable light wherein the electrical power source has a charging port in a predetermined location relative to the asymmetrical electrical terminal and the orienting member engages the orienting feature for connecting the asymmetrical electrical terminal to the asymmetrical electrical contact. The portable light wherein the electrical power source has a charging port that is in a predetermined location relative to the portable light when the asymmetrical electrical terminal is connected to the asymmetrical electrical contact. The portable light wherein the electrical power source has a charging port in a predetermined location relative to the asymmetrical electrical terminal. The portable light wherein the portable light has an opening in a predetermined location relative to the asymmetrical electrical contact, wherein the charging port aligns with the opening when the asymmetrical electrical terminal engages the asymmetrical electrical contact.

A portable light comprising: a light body for receiving an electrical power source therein and having a first opening at an end thereof through which an electrical power source can be received into and removed therefrom; the light body has a substantially symmetrical interior cavity about an axis that passes through the first opening and has a second opening through the light body to exterior the portable light; a light source supported on the light body for producing light when energized; an electrical power source having an exterior shape that is substantially symmetrical about an axis thereof and that is of compatible symmetrical shape and size with the cavity of the light body, the electrical power source having an asymmetrical electrical terminal at a first end and a recess or a projection or a recess and a projection at a second end opposite the first end, and having a charging port on the exterior thereof at a predetermined location relative to the asymmetrical electrical terminal thereof; an asymmetrical keying feature in the cavity of the light body for engaging the asymmetrical electrical terminal when the electrical power source is in a predetermined orientation in the cavity whereat the charging port of the electrical power source is in alignment with the second opening; and a cover for the first opening including an orienting member configured to engage the recess or the projection or both the recess and the projection of the electrical power source for moving the electrical power source into the predetermined orientation. The portable light wherein the asymmetrical electrical terminal is at an end of the electrical power source and the charging port thereof is on a side thereof, wherein the predetermined location of the charging port relative to the asymmetrical electrical terminal is at a predetermined distance from the end of the electrical power source and at a predetermined radial angle with respect to the asymmetrical electrical terminal. The portable light wherein: the predetermined radial angle is about zero degrees; and the charging port is closer to the end including the asymmetrical electrical terminal than to an end distal therefrom. The portable light wherein the asymmetrical keying feature is of a complementary shape and size to that of the asymmetrical electrical terminal of the electrical power source. The portable light wherein the light body has a cylindrical threaded end that defines the first opening and the cover has a cylindrical threaded end configured to engage the threaded end of the light body to cover the first opening. The portable light wherein the orienting member includes a coil spring extending in a direction towards the cavity of the light body. The portable light wherein the coil spring defines a central axis and wherein an end of the coil spring is formed to extend radially relative to the central axis for engaging the recess or the projection or both the recess and the projection of the electrical power source. The portable light further comprising an electrical switch disposed in the cover for coupling the electrical power source and the light source in circuit, wherein the coil spring provides an electrical connection to the electrical switch. The portable light wherein the light body includes a portion having the second opening therethrough, further comprising: a cover adjacent the portion of the light body and movable relative thereto for covering and uncovering the second opening; or a cover including a collar around the portion of the light body and slidable along the portion for covering and uncovering the second opening. The portable light including a seal disposed between the cover and the light body to seal the second opening when the second opening is covered by the cover. The portable light wherein the cover includes: an annular collar slidable along the light body for covering and uncovering the second opening; or an end cap slidable on the light body for covering and uncovering the second opening; or a cover movable toward and away from the light body for covering and uncovering the second opening; or a cover movable toward and away from the light body for covering and uncovering the second opening and of a size and shape to be retained in the second opening. The portable light wherein the asymmetrical electrical terminal of the electrical power source has a shape of a letter D, or of a keyhole, or of a circle missing a V-shaped part, or of a central part and a smaller satellite part, wherein the asymmetrical electrical terminal is a projection or a recess or both a recess and a projection. The portable light wherein the recess or the projection or both the recess and the projection at the second end of the electrical power source is a radial slot, or a radial ridge, or an X shaped projection or recess, or a circular pattern of projections and/or recesses, or a star shaped projection or recess, or an asterisk shaped projection or recess. The portable light further comprising: an actuator and electrical switch for coupling the electrical power source and the light source in circuit; or an actuator and electrical switch for coupling the electrical power source and the light source in circuit, wherein the actuator and electrical switch are disposed in the cover and wherein the electrical switch includes a coil spring that is an electrical connection of the electrical switch and is the orienting member. The portable light wherein the charging port of the electrical power source includes: an electrical connector, a coaxial connector, a USB connector, a mini-USB connector, a micro-USB connector, a USB-C connector, a Fire Wire connector, a Lightning connector, or a combination thereof.

A portable light comprising: a light source for producing light when energized; an electrical power source having a substantially symmetrical exterior shape about an axis thereof, having an asymmetrical electrical terminal and having a recess or a projection or both a recess and a projection thereon, the electrical power source having a charging port on the symmetrical exterior shape thereof at a predetermined location relative to the asymmetrical electrical terminal; a light body having a cavity that is of compatible symmetrical shape and size for receiving the electrical power source, and having a first opening of the cavity through which the electrical power source can be received into and removed from the cavity, the light body having a second opening through the light body between the cavity and exterior to the portable light; a contact assembly disposed in the cavity of the light body and having an asymmetrical keying feature configured to engage the asymmetrical electrical terminal of the electrical power source when the electrical power source is in a predetermined orientation in the cavity whereat the charging port of the electrical power source is in alignment with the second opening through the light body, whereby the charging port of the electrical power source is accessible through the second opening through the light body to receive charging current directly from an external charging source when the electrical power source is in the predetermined orientation in the cavity of the light body; and a cover configured to cover the first opening of the light body, the cover including an orienting member configured to engage the recess or the projection or both the recess and the projection of the electrical power source for moving the electrical power source in the cavity when the cover is placed on the light body to move the electrical power source into the predetermined orientation. The portable light wherein the asymmetrical electrical terminal of the electrical power source is at an end thereof and the charging port thereof is on a side thereof, wherein the predetermined location of the charging port of the electrical power source relative to the asymmetrical electrical terminal thereof is at a predetermined distance from the end of the electrical power source and at a predetermined radial angle with respect to an asymmetrical feature of the asymmetrical electrical terminal of the electrical power source. The portable light wherein: the predetermined radial angle with respect to the asymmetrical feature of the asymmetrical electrical terminal of the electrical power source is about zero degrees; and the charging port of the electrical power source is closer to the end thereof including the asymmetrical electrical terminal than to an end distal therefrom. The portable light wherein the asymmetrical keying feature of the contact assembly is of a complementary shape and size to that of the asymmetrical electrical terminal of the electrical power source. The portable light wherein the light body has a cylindrical threaded end that defines the first opening and wherein the cover has a cylindrical threaded end configured to engage the threaded end of the light body to cover the first opening of the light body. The portable light wherein the orienting member of the cover includes a coil spring extending from the cover in a direction to extend towards the cavity of the light body. The portable light wherein the coil spring defines a central axis and wherein an end of the coil spring is formed to extend radially relative to the central axis for engaging the recess or the projection or both the recess and the projection of the electrical power source. The portable light further comprising an electrical switch disposed in the cover for coupling the electrical power source and the light source in circuit, wherein the coil spring provides an electrical connection to the electrical switch. The portable light wherein the asymmetrical electrical terminal is at a first end of the electrical power source and wherein the recess or the projection or both the recess and the projection of the electrical power source is at a second end thereof. The portable light wherein the light body includes a portion having the second opening therethrough, further comprising: a cover adjacent the portion of the light body and movable relative to the portion for covering and uncovering the second opening through the light body; or a cover including a collar around the portion of the light body and slidable along the portion for covering and uncovering the second opening through the light body. The portable light including a seal disposed between the cover and the light body to seal the second opening when the second opening is covered by the cover. The portable light wherein the cover includes: an annular collar slidable along the light body for covering and uncovering the second opening through the light body; or an end cap slidable on the light body for covering and uncovering the second opening through the light body; or a cover movable toward and away from the light body for covering and uncovering the second opening through the light body; or a cover movable toward and away from the light body for covering and uncovering the second opening through the light body and of a size and shape to be retained in the second opening. The portable light wherein the asymmetrical electrical terminal of the electrical power source has a shape of a letter D, or of a keyhole, or of a circle missing a V-shaped part, or a central part and a smaller satellite part, wherein the asymmetrical electrical terminal is a projection or a recess or both a recess and a projection. The portable light wherein the recess or the projection or both the recess and the projection at the second end of the electrical power source is a radial slot, or a radial ridge, or an X shaped projection or recess, or a circular pattern of projections and/or recesses, or a star shaped projection or recess, or an asterisk shaped projection or recess. The portable light further comprising: an actuator and electrical switch for coupling the electrical power source and the light source in circuit; or an actuator and electrical switch for coupling the electrical power source and the light source in circuit, wherein the actuator and electrical switch are disposed in the cover and wherein the electrical switch includes a coil spring that provides an electrical connection to the electrical switch and provides the orienting member. The portable light wherein the charging port of the electrical power source includes: an electrical connector, a coaxial connector, a USB connector, a mini-USB connector, a micro-USB connector, a USB-C connector, a FireWire connector, a Lightning connector, or a combination thereof.

A portable light comprising: a light body having a forward end and a rearward end and an elongate portion therebetween with a cavity for receiving an electrical power source therein and having a first opening at the rearward end thereof through which an electrical power source can be received into and removed from the cavity thereof, wherein the cavity has a substantially cylindrical shape about an axis that passes through the first opening and has a second opening through the elongate portion of the light body to exterior the portable light; a light source supported proximate the forward end of the light body for producing light when energized; an electrical power source having an exterior shape that is substantially cylindrical about an axis thereof and that is of compatible cylindrical shape and size with the cavity of the light body, the electrical power source having an asymmetrical electrical terminal at a first end thereof and a recess or a projection or both a recess and a projection at a second end opposite the first end thereof, and the electrical power source having a charging port on the cylindrical exterior shape thereof at a predetermined location relative to the asymmetrical electrical terminal thereof; a contact assembly disposed in the cavity of the light body and having an asymmetrical keying feature of a shape and size for engaging the asymmetrical electrical terminal of the electrical power source when the electrical power source is in a predetermined orientation in the cavity whereat the charging port of the electrical power source is in alignment with the second opening through the elongate portion of the light body, whereby an external charging source may be directly connected through the second opening to the charging port of the electrical power source; and a tail cap configured to cover the first opening at the rearward end of the light body when the tail cap is rotated thereon, the tail cap including an orienting member extending towards the cavity configured to engage the recess or the projection or both the recess and the projection of the electrical power source for rotating the electrical power source in the cavity when the tail cap is rotated on the rearward end of the light body to rotate the electrical power source into the predetermined orientation and to cover the first opening. The portable light wherein the rearward end of the light body is a cylindrical and threaded end that defines the first opening and wherein the tail cap has a cylindrical threaded end configured to engage the threaded end of the light body to cover the first opening of the light body. The portable light wherein the orienting member of the tail cap includes a coil spring extending from the tail cap in a direction to extend towards the cavity of the light body. The portable light wherein the coil spring defines a central axis and wherein an end of the coil spring is formed to extend radially relative to the central axis for engaging the recess or the projection or both the recess and the projection at the second end of the electrical power source. The portable light further comprising an electrical switch disposed in the tail cap, wherein the coil spring provides an electrical connection to the electrical switch. The portable light further comprising: a cover adjacent the elongate portion of the light body and movable relative to the elongate portion for covering and uncovering the second opening through the light body; or a cover including a collar around the elongate portion of the light body and slidable along the elongate portion for covering and uncovering the second opening through the light body. The portable light including a seal disposed between the cover and the light body to seal the second opening when the second opening is covered by the cover. The portable light wherein the asymmetrical electrical terminal has a shape of a letter D, or of a keyhole, or of a circle missing a V-shaped part, or a central part and a smaller satellite part, wherein the asymmetrical electrical terminal is a projection or a recess or both a recess and a projection. The portable light wherein the recess or the projection or both the recess and the projection at the second end of the electrical power source is a radial slot, or a radial ridge, or an X shaped projection or recess, or a circular pattern of projections and/or recesses, or a star shaped projection or recess, or an asterisk shaped projection or recess. The portable light wherein the charging port of the electrical power source includes: an electrical connector, a coaxial connector, a USB connector, a mini-USB connector, a micro-USB connector, a USB-C connector, a Fire Wire connector, a Lightning connector, or a combination thereof.

An electrical power source for a portable light comprises: a housing having an exterior that is substantially symmetrical about an axis thereof and that is of compatible symmetrical shape and size with a cavity of a light body with which it is intended to be utilized; an asymmetrical electrical terminal at a first end of the housing and a recess or a projection or both a recess and a projection at a second end thereof; and a charging port on the exterior thereof at a predetermined location relative to the asymmetrical electrical terminal; wherein the asymmetrical electrical terminal is configured to engage an asymmetrical keying feature of the cavity of the light body with which it is intended to be utilized; and wherein the recess or the projection or both the recess and the projection are configured for moving the electrical power source in the cavity of the light body with which it is intended to be utilized to move the asymmetrical electrical terminal into engagement with the asymmetrical keying feature. The electrical power source wherein the asymmetrical electrical terminal has a shape of a letter D, or of a keyhole, or of a circle missing a V-shaped part, or a central part and a smaller satellite part, wherein the asymmetrical electrical terminal is a projection or a recess or both a recess and a projection. The electrical power source wherein the recess or the projection or both the recess and the projection at the second end thereof is a radial slot, or a radial ridge, or an X shaped projection or recess, or a circular pattern of projections and/or recesses, or a star shaped projection or recess, or an asterisk shaped projection or recess. The electrical power source wherein the recess or the projection or both the recess and the projection is a radial slot, or a radial ridge, or an X shaped projection or recess, or a circular pattern of projections and/or recesses, or a star shaped projection or recess, or an asterisk shaped projection or recess. The electrical power source wherein the charging port includes: an electrical connector, a coaxial connector, a USB connector, a mini-USB connector, a micro-USB connector, a USB-C connector, a Fire Wire connector, a Lightning connector, or a combination thereof. The electrical power source further comprising: a light body having a cavity of compatible symmetrical shape and size for receiving the electrical power source therein, and having a first opening through which the electrical power source can be received into and removed from the cavity, the light body having a second opening between the cavity and exterior to the portable light; and an asymmetrical keying feature in the cavity of the light body configured to engage the asymmetrical electrical terminal when the electrical power source is in a predetermined orientation in the cavity whereat the charging port of the electrical power source is in alignment with the second opening; whereby the charging port of the electrical power source is accessible through the second opening to receive charging current directly from an external charging source when the electrical power source is in the predetermined orientation in the cavity. The electrical power source further comprising: a cover for the first opening of the light body, the cover including an orienting member configured to engage the recess or the projection or both the recess and the projection of the electrical power source for moving the electrical power source into the predetermined orientation when the cover is placed on the light body.

As used herein, the terms “about,” “approximate” and/or “approximately” mean that dimensions, sizes, formulations, parameters, shapes and other quantities and characteristics are not and need not be exact, but may be approximate and/or larger or smaller, as desired, reflecting tolerances, conversion factors, rounding off, measurement error and the like, judgment, and other factors known to those of ordinary skill in the art. In general, a dimension, size, formulation, parameter, shape or other quantity or characteristic is “about” or “approximate” or “substantial” or “substantially” whether or not expressly stated to be such. It is noted that embodiments of very different sizes, shapes and dimensions may employ the described arrangements.

Although terms such as “front,” “back,” “rear,” “side,”“end,” “top,” “bottom,” “up,” “down,” “left,” “right,” “upward,” “downward,” “forward,” “backward,” “under” and/or “over,” “vertical,” “horizontal,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

As used herein, the term “and/or” encompasses both the conjunctive and the disjunctive cases, so that a phrase in the form “A and/or B” encompasses “A” or “B” or “A and B.” Likewise, a phrase in the form “A, B and/or C” or a phrase in the form “A and/or B and/or C” includes “A,” “B,” “C,” “A and B,” “A and C,” “B and C,” and “A and B and C.” In addition, the term “at least one of” one or more elements is intended to include one of any one of the elements, more than one of any of the elements, and two or more of the elements up to and including all of the elements, and so, e.g., phrases in the form “at least one of A, B and C” include “A,” “B,” “C,” “A and B,” “A and C,” “B and C,” and “A and B and C.”

As used herein, the term “predetermined” means determined in advance or before hand with respect to whatever the term pertains to. The term may be used with respect to a physical object or thing and/or with respect to an intangible thing, e.g., a signal or data, and the like. Examples thereof may include a fixed value, position, condition and/or limit, however, predetermined is not limited to a fixed value, position, condition and/or limit. A predetermined value, condition and/or limit may change or otherwise vary over time, over a sequence and/or over a randomized series of values, conditions and/or limits.

As used herein, the term “plurality” means plural, two or greater in number of whatever the term pertains to, i.e. more than one. The term may be used with respect to a physical object or thing and/or with respect to an intangible thing, e.g., a signal or data, and the like. Examples thereof may include a fixed or movable thing, a fixed value, a changeable value, position, condition and/or limit, and the like.

As used herein, the terms “substantial” and “substantially” mean that the thing referred to as being “substantial” or “substantially” is sufficiently similar in form and/or function as to usable in the invention in a manner that is encompassed or suggested by the description and/or claims herein, and/or an equivalent thereof. The terms “substantial” and “substantially” can include and/or can be in addition to the meaning of the terms “about,” “approximate” and/or “approximately” herein.

As used herein “transverse” refers to crossing, lying across, being across, in a cross direction, or crosswise, whether perpendicularly or at an acute or obtuse angle, and to directions so arranged or configured. That arrangement can also be said to intersect or pass through or to have an intersection. With regard to things that are three dimensional, transverse can mean that they encompass a common volume where they intersect or that they do not have a volume in common. In general, the terms “transverse” and “lateral” as well as and “transversely” and “laterally” may be used interchangeably unless the context indicates otherwise.

A fastener as used herein may include any fastener or other fastening device that may be suitable for the described use, including threaded fasteners, e.g., bolts, screws and driven fasteners, as well as pins, rivets, nails, spikes, barbed fasteners, clips, clamps, nuts, speed nuts, cap nuts, acorn nuts, and the like. Where it is apparent that a fastener would be removable in the usual use of the example embodiment described herein, then removable fasteners would be preferred in such instances. A fastener may also include, where appropriate, other forms of fastening such as a formed head, e.g., a peened or heat formed head, a weld, e.g., a heat weld or ultrasonic weld, a braze, an adhesive, a clasp, a clip, a latch, and the like.

As used herein, the terms “connected” and “coupled” as well as variations thereof may or may not be intended to be exact synonyms, but may also encompass some similar things and some different things, and those terms are used interchangeably herein. While the term “connected” as indicated by its context may be used generally to refer to elements that have a direct electrical and/or physical contact to each other, whereas the term “coupled” as indicated by its context may be used generally to refer to elements that have an indirect electrical and/or indirect physical contact with each other, e.g., via one or more intermediate elements, so as to cooperate and/or interact with each other, and may include elements in direct contact as well.

The term “battery” may be used herein to refer generally to a source of electrical power as well as to an electro-chemical device comprising one or more electro-chemical cells and/or fuel cells, and so a battery may include a single cell or plural cells, whether as individual units or as a packaged unit. A battery is one example of a type of an electrical power source suitable for a portable or other device. Such devices could employ power sources including, but not limited to, fuel cells, super capacitors, solar cells, and the like, as well as an electro-chemical battery. Any of the foregoing may be intended for a single use or for being rechargeable or for both, and/or plural ones thereof may be combined into a battery pack or battery assembly or other such assembly or pack, and any, some or all thereof may be referred to herein under the general term battery.

Various embodiments of a battery may have one or more battery cells, e.g., one, two, three, four, or five or more battery cells, as may be deemed suitable for any particular device. A battery may employ various types and kinds of battery chemistry types, e.g., a carbon-zinc, alkaline, lead acid, nickel-cadmium (Ni—Cd), nickel-metal-hydride (NiMH) or lithium-ion (Li-Ion) or lithium-ion-phosphate battery type, of a suitable number of cells and cell capacity for providing a desired operating time and/or lifetime for a particular device, and may be intended for a single use or for being rechargeable or for both. Examples may include a four cell NiMH battery producing about 4.8 volts, a Li-Ion battery typically producing about 3.5-3.7 volts, or a two-cell Li-Ion battery typically producing about 7 volts, it being noted that the voltages produced thereby will be higher when approaching full charge and will be lower in discharge, particularly when providing higher current and when reaching a low level of charge, e.g., becoming discharged. It is noted that the arrangement described herein preferably receives a rechargeable battery or power source, however, single-use power source an be employed.

As used herein “dual-fuel” refers to lights and electronic devices, e.g., lights, flashlights, lanterns and the like, that can be powered by two or more sources of electrical power, e.g., batteries, of two or more different sizes, types, and/or kinds, at different times and/or at the same time. “Dual-fuel” may also refer to assemblies and/or packages of power sources, battery assemblies and/or battery packs, that can receive or contain two or more sources of electrical power, e.g., batteries, of two or more different sizes, types, and/or kinds, at different times and/or at the same time. The light and arrangement described and claimed herein may be a dual-fuel device and may employ dual-fuel power sources.

While the present invention has been described in terms of the foregoing example embodiments, variations within the scope and spirit of the present invention as defined by the claims following will be apparent to those skilled in the art. For example, while the example power source described has a cylindrical shape which is a shape that is symmetrical about its longitudinal axis and is rotatable in the cavity 122 of light body 120, power sources of other symmetrical shapes that can be rotated in cavity 122 may be employed, including, e.g., those having a rectangular, square, pentagonal, hexagonal, octagonal cross-sectional shape and the like, which may be rotated in, e.g., a cylindrical cavity.

Further, while the examples described herein are typically smaller lights that a user can carry in a hand or on his body, the invention may be employed in many different types and kinds of lights and other devices, whether or not easily portable, that include a rechargeable source of electrical power that has a charging port, e.g., an externally accessible charging connector, which can be accessed from outside the light or device for connecting an external source of charging power directly to the charging port of the source of electrical power while it is in the light or device.

While the example source of electrical power 200 is illustrated as having a generally symmetrical shape, e.g., a generally cylindrical shape, except for the keying member 220 thereof, i.e. asymmetrical electrical terminal 220, the power source 200 could be of any shape that would permit it to be placed into the light 100 in more than one orientation except for the keying action of its keying feature 220 with a complementary keying feature 184 of the light. For example, power source 200 could have a circular, rectangular, square, hexagonal, octagonal or other cross-sectional shape not defining a unique radial orientation except for the keying feature 220 thereof, and power sources 200 having such shapes may be rotated in, e.g., a cylindrical cavity.

The terms engaging feature, keying member and keying feature are sometimes used interchangeably herein in relation to the features 180, 184 and/or 220 that determine the position of the power source 200 in the cavity 122 of the light body 120 such that the charging port or charging connector 250 of the power source 200 is aligned with the opening 124 in the light body 120. A keying feature may be concave or convex, a recess or a projection, protruding or indented, or any combination thereof.

While the preferred power source 200 is a rechargeable Lithium-ion battery 200, other types of rechargeable batteries may be utilized, and single-use batteries may also be employed, and so portable light 100 maybe a dual-fuel light. Rechargeable power sources having their charging port in a different location than that of the example battery 200 may be employed, and the location of charging opening 124 may be in another suitable location of light body 120 for aligning with charging port 250 to enable direct access to charging port 250 from charging sources external to light 100.

While certain features may be described as a raised feature, e.g., a ridge, boss, flange, projection, detent, or other raised feature, such feature may be positively formed or may be what remains after a recessed feature, e.g., a groove, slot, hole, indentation, recess, detent, or other recessed feature, is made. Similarly, while certain features may be described as a recessed feature, e.g., a groove, slot, hole, indentation, recess or other recessed feature, such feature may be positively formed or may be what remains after a raised feature, e.g., a ridge, boss, flange, projection or other raised feature, is made. In addition, where a raised feature engages a recessed feature, such as a partially or fully cylindrical projection that engages a complementary partially or fully cylindrical receptacle, the relative positions of the raised and recessed features may be interchanged or other wise modified.

While the example port cover 126 for charging opening 124 in the illustrated example is a collar 126 that is slidable longitudinally along light body 120, port cover 126 may be of any desirable form, e.g., port cover 126 may have an opening similar to and slightly larger than charging opening 124 and be rotatable around light body 120 or may be a resilient plug 126 that fits tightly in charging opening 124 or may be omitted.

While the illustrated embodiment of example cover 126 for charging opening 124 is illustrated as being captive on the light, e.g., encircling a part of the light to slide thereon, the cover 126 may be separate from and not connected to the light or may be attached thereto by a lanyard, a tether, a fastener or another retainer. For example, portable light 100 could employ a snap-in, snap-out cover 126 which may or may not include a physical attachment to the light.

While the example orienting member 146 of cover 140 is a coiled spring, other configurations may be employed, e.g., a leaf spring or a spring-biased member having a projection compatible with the engaging feature 232 of power source 200, or dual coiled springs having plural engaging tips 146T. Such projection or projections could be, e.g., one or more raised ridges of compatible shape and size for engaging with feature 232 as described. Orienting member 146 may also be of a resilient or flexible material that engages with and disengages from orienting feature 232 by flexing or frictional contact, and may have one or more engaging tips 146T.

Alternatively, orienting member 146 may be omitted entirely and the orientation of power source 200 in light 100 may be accomplished by a user using manual means, e.g., by hand, as described herein.

Alternatively to the illustrated example, orienting feature 232 of power source 200 may be configured in a star or asterisk like shape, thereby to provide, e.g., five or six positions whereat spring 146 can engage with feature 232 whereby a lesser rotation of cover 140 is needed to make engagement therewith.

In a further alternative, two openings 124 could be provided 180° apart around light body 120 so that a rotation of power source 200 of 180° or less would be required to bring charging port 250 of power source 200 into a predetermined alignment with a charging opening 124 to provide a charging port 150 for connecting a charging cable directly into charging port 250 of power source 200.

When both of the foregoing alternatives are provided, then 270° or less of rotation would be needed to properly align power source 200 to provide a charging port 150 of light 100.

Each of the U.S. Provisional Applications, U.S. Patent Applications, and/or U.S. Patents, identified herein is hereby incorporated herein by reference in its entirety, for any purpose and for all purposes irrespective of how it may be referred to or described herein.

Finally, numerical values stated are typical or example values, are not limiting values, and do not preclude substantially larger and/or substantially smaller values. Values in any given embodiment may be substantially larger and/or may be substantially smaller than the example or typical values stated.

1. A rotationally symmetrical electrical power source with one asymmetrical electrical terminal that is centrally located relative to an axis of rotation of the electrical power source and that is either raised or recessed.

2. The rotationally symmetrical electrical power source of claim 1 wherein the one asymmetrical electrical terminal has a shape of a letter D, or of a keyhole, or of a circle missing a V-shaped part, or of a central part and a satellite part.

3. The rotationally symmetrical electrical power source of claim 1 in combination with:
an asymmetrical electrical contact that has an electrical contact that is recessed relative to an asymmetrical keying feature; or
an asymmetrical electrical contact that has an electrical contact that is recessed relative to an electrically insulating asymmetrical keying feature.

4. The rotationally symmetrical electrical power source of claim 3 wherein the asymmetrical keying feature has a shape of a letter D, or of a keyhole, or of a circle missing a V-shaped part, or of a central part and a satellite part.

5. The rotationally symmetrical electrical power source of claim 1 wherein the electrical power source has an orienting feature that is raised or recessed.

6. The rotationally symmetrical electrical power source of claim 5 wherein the orienting feature is centrally located relative to the axis of rotation of the electrical power source and is at an end thereof opposite to the asymmetrical terminal.

7. The rotationally symmetrical electrical power source of claim 6 in combination with a rotatable cover for retaining the electrical power source and having an orienting member to rotate the electrical power source.

8. The rotationally symmetrical electrical power source of claim 7 wherein the electrical power source has a charging port in a predetermined location relative to the asymmetrical electrical terminal and the orienting member engages the orienting feature for moving the asymmetrical electrical terminal to engage an asymmetrical electrical contact.

9. The rotationally symmetrical electrical power source of claim 8 wherein the electrical power source has a charging port that is in a predetermined location relative to a body for receiving the electrical power source when the asymmetrical electrical terminal engages the asymmetrical electrical contact.

10. The rotationally symmetrical electrical power source of claim 1 wherein the electrical power source has a charging port in a predetermined location relative to the asymmetrical electrical terminal.

11. The rotationally symmetrical electrical power source of claim 10 in combination with a body for receiving the electrical power source having an opening in a predetermined location relative to the asymmetrical electrical contact, wherein the charging port aligns with the opening when the asymmetrical electrical terminal engages the asymmetrical electrical contact.

12-59. (canceled)

60. The rotationally symmetrical electrical power source of claim 1 wherein the one asymmetrical electrical terminal is configured to engage an asymmetrical electrical contact of complementary shape.

61. A rotationally symmetrical electrical power source for a portable light comprises:
a housing having an exterior that is substantially rotationally symmetrical about an axis thereof and that is of compatible symmetrical shape and size with a cavity with which it is intended to be utilized;
an asymmetrical electrical terminal at a first end of the housing;
wherein the asymmetrical electrical terminal is configured to engage an asymmetrical keying feature of the cavity with which the electrical power source is intended to be utilized.

62. The rotationally symmetrical electrical power source of claim 61 wherein the asymmetrical electrical terminal has a shape of a letter D, or of a keyhole, or of a circle missing a V-shaped part, or a central part and a smaller satellite part, wherein the asymmetrical electrical terminal is a projection or a recess or both a recess and a projection.

63. The rotationally symmetrical electrical power source of claim 61 further comprising:
the housing having a recess or a projection or both a recess and a projection at a second end thereof;
wherein the recess or the projection or both the recess and the projection are configured for moving the electrical power source in the cavity with which it is intended to be utilized to move the asymmetrical electrical terminal into engagement with the asymmetrical keying feature.

64. The rotationally symmetrical electrical power source of claim 63 wherein the recess or the projection or both the recess and the projection is a radial slot, or a radial ridge, or an X shaped projection or recess, or a circular pattern of projections and/or recesses, or a star shaped projection or recess, or an asterisk shaped projection or recess.

65. The rotationally symmetrical electrical power source of claim 63 in combination with:
a cover for the cavity with which the electrical power source is intended to be utilized, the cover including an orienting member configured to engage the recess or the projection or both the recess and the projection of the electrical power source for moving the electrical power source into engagement with the asymmetrical keying feature when the cover covers the cavity.

66. The rotationally symmetrical electrical power source of claim 61 further comprising:
a charging port on the exterior thereof at a predetermined location relative to the asymmetrical electrical terminal.

67. The rotationally symmetrical electrical power source of claim 66 wherein the charging port includes: an electrical connector, a coaxial connector, a USB connector, a mini-USB connector, a micro-USB connector, a USB-C connector, a Fire Wire connector, a Lightning connector, or a combination thereof.

68. The rotationally symmetrical electrical power source of claim 61 in combination with:
a body having the cavity which is of compatible symmetrical shape and size for receiving the electrical power source therein, and having a first opening through which the electrical power source can be received into and removed from the cavity, the body having a second opening between the cavity and an exterior to the body,
wherein the asymmetrical keying feature is disposed in the cavity of the body to engage the asymmetrical electrical terminal when the electrical power source is in a predetermined orientation in the cavity whereat the charging port of the electrical power source is in alignment with the second opening;
whereby the charging port of the electrical power source is accessible through the second opening to receive charging current directly from an external charging source when the electrical power source is in the predetermined orientation in the cavity.

69. The rotationally symmetrical electrical power source of claim 68 wherein the housing thereof has a recess or a projection or both a recess and a projection at a second end thereof; further comprising:
a cover for the first opening of the body, the cover including an orienting member configured to engage the recess or the projection or both the recess and the projection of the electrical power source for moving the electrical power source into the predetermined orientation when the cover is placed on the light body.
